(19) United States
(12) Patent Application Publication
(10) Pub. No.: US 2012/0247791 A1
(43) Pub. Date: Oct. 4, 2012

(54) ELECTRONIC PRESSURE GAUGE

(76) Inventors: Andrzej E. Kuczek, Bristol, CT (US); Joseph B. Wysocki, Somers, CT (US); Thierry Carriere, Westfield, MA (US)

(21) Appl. No.: 13/509,050

(22) PCT Filed: Dec. 22, 2009
(86) PCT No.: PCT/US09/06666

§ 371 Date: May 10, 2012

(51) Int. Cl. A62C 13/76; G01L 9/00

(52) U.S. Cl. 169/23; 73/723

(57) ABSTRACT

A pressure gauge 20 includes a diaphragm 36 having a first side 64 and a second side 66 and occupying a first state or a second state as a function of a pressure of a fluid 59 in contact with the first side 64. A sensor 68 communicable with the second side 66 of the diaphragm 36 senses the first state or the second state to produce a signal which is processed by a circuit 40 to produce an output. An indicator 42 provides an output representing the first state or the second state of the diaphragm 36 based on the output from the circuit 40.

### BACKGROUND

Pressurized vessels often require a minimum and/or maximum pressure in the vessel to ensure a reliable release of the stored agent from the vessel when needed. For example, fire extinguishers must maintain a minimum pressure inside the vessel to ensure an optimal release of extinguishing agent when needed in an emergency situation. To indicate the internal pressure conditions of the vessel to a user and/or service agent, a pressure gauge is typically provided in communication with the pressurized contents of the vessel. Pressure gauges must not only reliably indicate pressure readings to a user, but must also be made leakproof to ensure the contents of the pressurized vessel are kept at the minimum or maximum allowable pressure over time.

One of the most common pressure gauges in use today is the bourdon tube pressure gauge. A bourdon tube is a thin-walled, coiled metal tube that is flattened diametrically on opposite sides, having two long flat sides and two short round sides. Pressure communicated from a pressurized vessel to the inside of the tube causes distention of the flat sections and distorts the tube to a round cross-section, causing it lengthen along a curve. The movement of the tip of the tube is then used to position a needle pointer to indicate a pressure reading on the gauge. Although bourdon tube technology has been used for over a century, its design and manufacturing process places a high demand on manufacturers to produce a quality, leakproof product for a reasonable price. Manufacture of the tube, including welding, brazing, and manipulation such as flattening and bending it lengthwise into an arc, introduces a greater potential for defects in the tube that can lead to leak paths for the pressurized fluid. Furthermore, electrochemical corrosion between the delicate metallic layers of the tube can introduce leak paths over the life of the pressure gauge, causing pressure to be lost from the vessel. For pressurized vessels such as fire extinguishers, this leads to replacement costs as well as the possibility that the extinguisher will not function correctly when needed in an emergency situation.

### SUMMARY

In one embodiment, a pressure gauge comprises a bi-state diaphragm having a first side and a second side. The diaphragm occupies a first state at or above a threshold pressure of a fluid in contact with the first side and is resiliently biased to occupy a second state below the threshold pressure. A switch senses the second side of the diaphragm and occupies an open or closed state in response to the first state and the second state of the diaphragm. A circuit processes a signal from the switch representing the open or close state to provide an output. Based on the output from the circuit, an indicator provides a visual output representing the first state or the second state of the diaphragm and an alarm provides an audible output representing the first state or the second state. Enclosed within a housing, a printed circuit board supports the switch, circuit, indicator, and alarm.

In another embodiment, a head comprises a body for attachment to a pressurized vessel and having a passage for directing fluid from the pressurized vessel. A housing attached to the body has an enclosed space separated from the passage by a bi-state diaphragm. The diaphragm has a first side facing the passage and a second side facing the enclosed space, and occupies a first state at or above a threshold pressure of a fluid in contact with the first side, and is resiliently biased to occupy a second state below a threshold pressure of a fluid in contact with the first side. The enclosed space comprises a sensor, circuit, and an indicator. The sensor senses the first state or the second state of the diaphragm and produces a signal representing the sensed first or second state. The circuit processes the signal representing the sensed first or second state to provide an output, and the indicator provides a visual output representing the first or second sensed state of the diaphragm based on the output of the circuit.

In yet another embodiment, a fire extinguisher comprises a vessel containing an extinguishing agent under pressure, and a head attached to the vessel having a pressure sensor, a first passage for directing the extinguishing agent from the vessel to an outlet, and a second passage for directing the extinguishing agent to the pressure sensor. The pressure sensor comprises a bi-state diaphragm communicating with the second passage and occupying a first state at or above a threshold pressure of the extinguishing agent in contact with the diaphragm, and a second state below a threshold pressure of the extinguishing agent in contact with the diaphragm. The pressure sensor further comprises a switch, a circuit, an indicator, and an alarm. The switch senses the first state or the second state of the diaphragm and produces a signal representing the sensed first or second state. The circuit processes the signal representing the sensed first or second state to provide an output. Based on the output from the circuit, an indicator provides a visual output representing the first state or the second state of the diaphragm and an alarm provides an audible output representing the first state or the second state.

### BRIEF DESCRIPTION OF THE DRAWINGS

FIG. 1 is a perspective view of a fire extinguisher with a pressure gauge and head.

FIG. 2 is an exploded view of the pressure gauge shown in FIG. 1.

FIG. 3A is a cross section of the pressure gauge and head of FIG. 1, showing a diaphragm in a first state.

FIG. 3B is a cross section of the pressure gauge and head of FIG. 1, showing a diaphragm in a second state.

FIG. 4A is a frontal view of the pressure gauge of FIG. 3A.

FIG. 4B is a frontal view of the pressure gauge of FIG. 3B.

FIG. 5A is an electronic block diagram of a pressure gauge, showing a diaphragm in a first state.

FIG. 5B is an electronic block diagram of a pressure gauge, showing a diaphragm in a second state.

### DETAILED DESCRIPTION

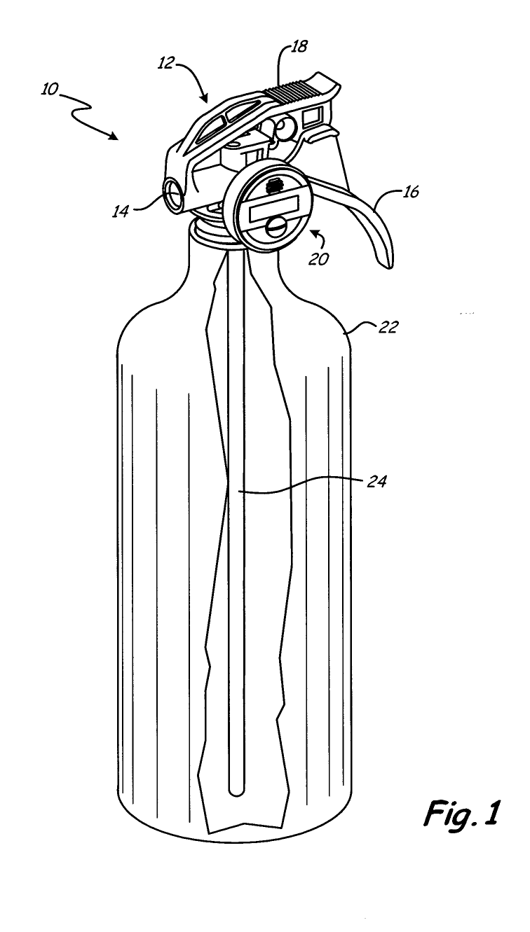

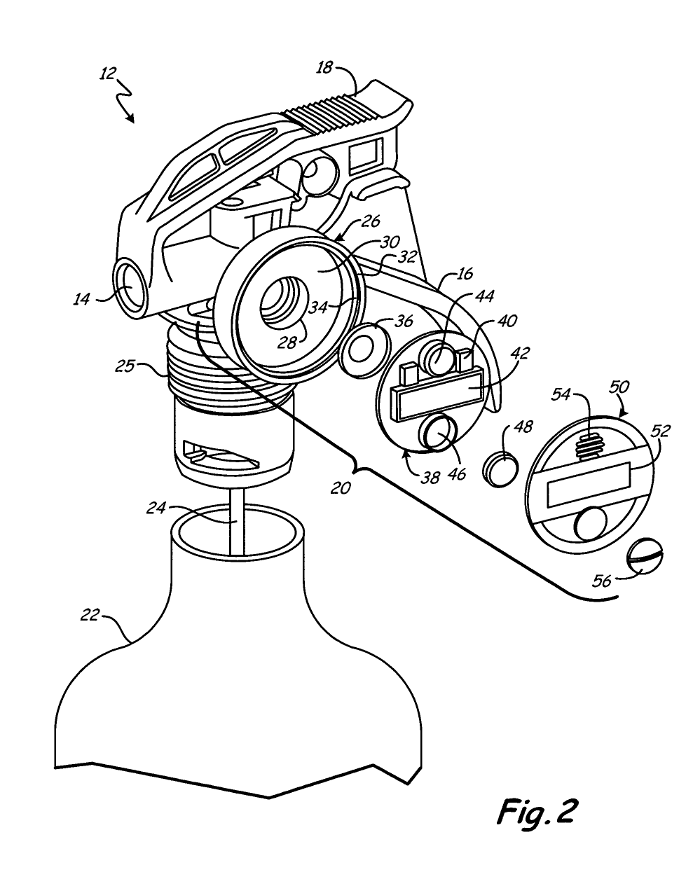

FIG. 1 is a perspective view of fire extinguisher 10, showing head 12 having outlet 14, handle 16 and thumb rest 18; pressure gauge 20; vessel 22; and siphon tube 24 shown through a cutaway view inside vessel 22. Head 12 is attached to vessel 22 using an airtight connection, such as a screw fit connection, for example. Vessel 22 contains a pressurized propellant (or carrier) fluid and a fire extinguishing agent. Propellant fluid may include, for example, compressed nitrogen gas. A valve located inside of head 12 prevents fire extinguishing agent and the propellant fluid inside of vessel 22 from escaping through outlet 14 to atmosphere when fire extinguisher 10 is in its normal, steady state. Operation of handle 16 by squeezing it toward thumb rest 18 mechanically opens the valve, allowing pressurized propellant fluid to push extinguishing agent and the propellant fluid through siphon tube 24 having an opening near the bottom of vessel 22, and eventually through outlet 14 to atmosphere. Extinguishing agent can include a powder, liquid, or gas. Pressure gauge 20 is connected to head 12, and as will be described in more detail with reference to FIGS. 2-5B, senses the pressure of pressurized propellant fluid contained within vessel 22 and provides an indication of that pressure. For example, pressure gauge 20 may indicate to a user of fire extinguisher 10 whether the pressure of propellant fluid contained within vessel 22 is sufficient or insufficient for proper operation of extinguisher 10 to extinguish a fire.

FIG. 2 is a perspective view of head 12 and vessel 22 in a detached state, and an exploded view of pressure gauge 20, further showing threads 25; pressure gauge housing 26 having orifice 28, flange 30, and rim 32 having recessed ledge 34; diaphragm 36; printed circuit board 38 having circuit 40, indicator 42, alarm 44, and battery receptacle 46; battery 48; gauge cover 50 having window 52 and grill 54; and battery cap 56.

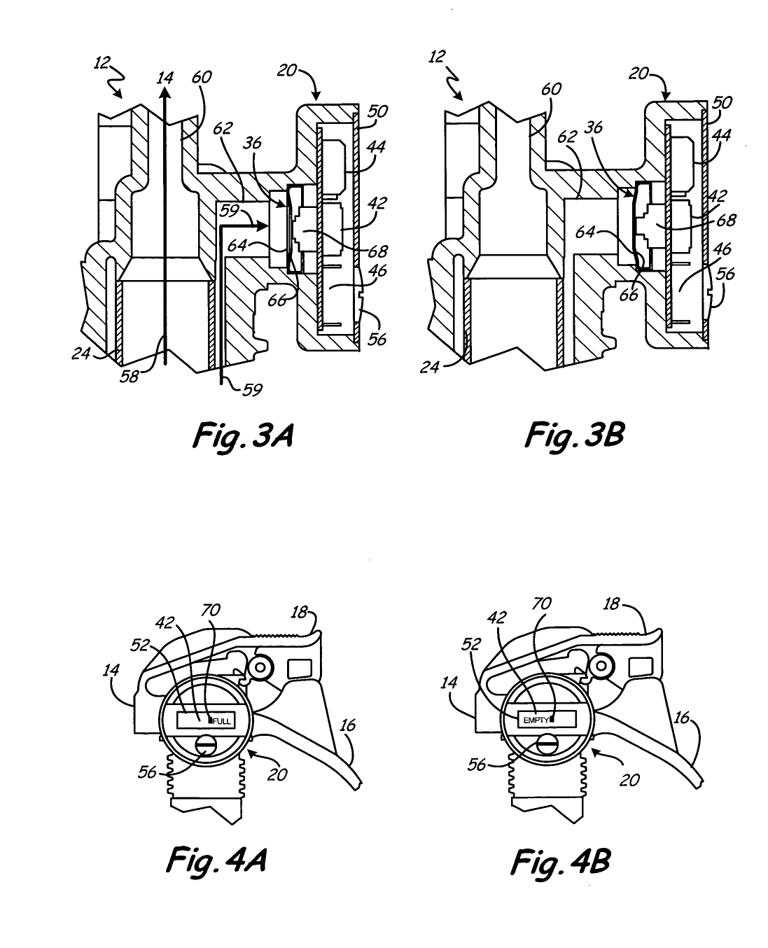

Head 12 may be connected to vessel 22 to form an airtight connection, for example, by a screw fit connection using threads 25. As shown in more detail with reference to FIGS. 3A and 3B, head 12 communicates a fluid from vessel 22 through siphon tube 24 and eventually through orifice 28, where it communicates with a first side of diaphragm 36. Pressure gauge housing 26 may be made of plastic, for example, that is integrally molded with head 12. By integrally molding head 12 and housing 26 as one piece, the manufacturing process is simplified, leading to lower costs and reduced defect rates. This is in contrast to existing bourdon tube pressure gauges which typically manufacture housing 26 as a separate metal piece that must then be assembled in an air-tight manner onto head 12, thereby introducing a potential leak path between housing 26 and the body of head 12. Alternatively, if head 12 is made of a metal or metal alloy, pressure gauge housing 26 may be connected to head 12 using a suitable air-tight connection. This may include, for example, screw fit or push fit connections utilizing a sealant or adhesive. If pressure gauge housing 26 comprises a metal or metal alloy, it may also be welded to head 12.

Diaphragm 36 is shown as a separate component in FIG. 2, which may be made of plastic or a corrosion resistant metal or metal alloy comprising stainless steel, brass, or aluminum, for example. However, if a plastic diaphragm 36 is used in conjunction with a plastic housing 26, it may be integrally molded with housing 26. By integrally molding diaphragm 36 to span orifice 28 or a passage leading to orifice 28, the potential for leakage at or around orifice 28 is almost eliminated. If diaphragm 36 is installed as a separate component, there are numerous simple and inexpensive ways it can be fitted into orifice 28 in a leak-tight manner. For example, diaphragm 36 could be installed into orifice 28 using a tight push-fit connection, which could be reinforced with a sealant or adhesive applied to circumscribe diaphragm 36. Alternatively, a plastic diaphragm 36 could be laser welded into orifice 28. The relative thickness and corrosion resistant properties of diaphragm 36, along with its simple design and ease of assembly and manufacture, results in a low-cost alternative to bourdon tubes with a much lower defect rate and potential for leak paths to form.

FIG. 2 further shows printed circuit board 38 having circuit 40, indicator 42, alarm 44, and battery receptacle 46. As shown and described in more detail with reference to FIGS. 3A and 3B, a sensor is also coupled to the backside of printed circuit board 38 for communication with diaphragm 36, and functions to provide a signal to circuit 40 representing a sensed state of diaphragm 36. Alarm 44 may be a piezoelectric buzzer, for example, and is activated by a signal received from circuit 40. Indicator 42 is shown as a liquid crystal display (LCD), but may also comprise a colored light emitting diode (LED) or other visual indicator, and indicates the pressure contained within vessel 22 as a function of a signal received from circuit 40. Battery 48 is placed in battery receptacle 46 to provide power to the components of printed circuit board 38, and is secured in place by battery cap 56 once pressure gauge 20 is fully assembled. Battery 48 may include, for example, a button cell battery such as that commonly used in watches, calculators, and other small electronic devices.

To assemble pressure gauge 20, printed circuit board may be push-fit into housing 26, forming a tight fit with a first inner diameter of rim 32, or may loosely fit within the inner diameter being secured to flange 30 with adhesive applied to the backside of printed circuit board 38. Gauge cover 50 may then be push-fit into a second inner diameter of rim 32 larger than the first inner diameter to abut recessed ledge 34 and form a flush face for pressure gauge 20. Gauge cover 50 should be placed over printed circuit board 38 such that indicator 42 may be seen through window 52, and alarm 44 may transmit sound through grill 54. It may be appreciated that a sealant or adhesive may be used to support either printed circuit board 38 or gauge cover 50 in connection with housing 26, and that other suitable means of assembly may be used.

FIGS. 3A and 3B are a cross section of head 12 and pressure gauge 20, further showing extinguishing agent 58, propellant fluid 59, outlet passage 60, pressure gauge passage 62, first side 64 and second side 66 of diaphragm 36, and sensor 68. Extinguishing agent 58 from siphon tube 24 is directed through the body of head 12 to travel through outlet passage 60 eventually leading to outlet 14. Propellant fluid 59 travels around siphon tube 24 through pressure gauge passage 62 leading to second side 66 of diaphragm 36. As shown in FIG. 3A, when vessel 22 contains a sufficient pressure, fluid 59 pushes on first side 64 of diaphragm 36, causing it to occupy a first state having a partially or wholly concave first side 64 and convex second side 66. In the first state, second side 66 of diaphragm physically communicates with sensor 68 to indicate sufficient pressure is contained in vessel 22. As shown in FIG. 3B, when vessel 22 does not contain a sufficient pressure level, fluid 59 does not push with the same force on first side 64 of diaphragm 36, thereby causing it to occupy a second state having a partially or wholly convex first side 64 and concave second side 66. Alternatively, diaphragm 36 in its second state may have a substantially planar first side 64 and second side 66 in the absence of sufficient pressure from vessel 22. In the second state shown in FIG. 3B, second side 66 of diaphragm physically communicates with sensor 68 to indicate insufficient pressure is contained in vessel 22. Alternatively, a lack of physical communication between second side 66 of diaphragm 36 and sensor 68 may indicate insufficient pressure contained in vessel 22.

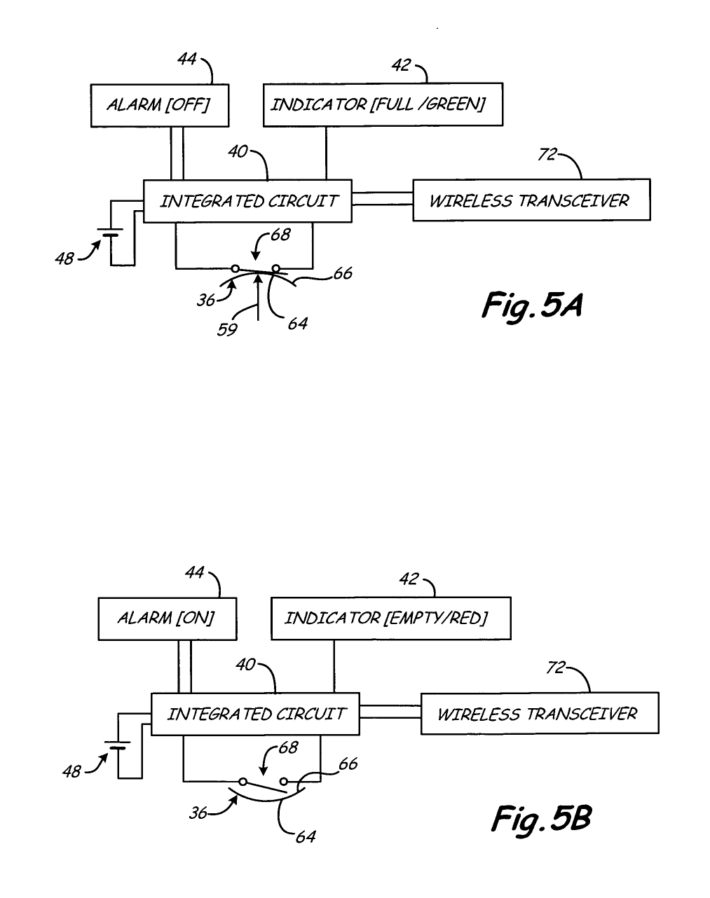

In the embodiment shown in FIGS. 3A and 3B, sensor 68 is a miniature switch having means for communicating with the second side 66 of diaphragm 36 such that the diaphragm turns the switch on (or closed) in its first state and off (or open) in its second state. For example, second side 66 could communicate with a button that is pressed when diaphragm 36 is in its first state, and depressed when in its second state, thereby completing or breaking a circuit in the switch. Whether the button is on or off (i.e., pressed or depressed) could then be used to represent a digital binary 0 or 1 signal to indicate the first state or second state of diaphragm 36, corresponding to a “full” or “empty” condition in vessel 22, for example. This signal may then be sent to circuit 40 for further processing as described with reference to FIGS. 5A and 5B. The button may be mechanically biased to assume the depressed position, for example, by utilizing a spring mechanism, thereby assuming an off position as soon as diaphragm 36 occupies the second state. Alternatively, second side 66 of diaphragm 36 may be physically linked to the button of the miniature switch, such that it moves with diaphragm 36 when it assumes the second state. This may be accomplished, for example, by using adhesive to adhere the button to second side 66. It may also be appreciated that a miniature switch could be used that does not comprise a button. For example, if diaphragm 36 is made of a conductive metal, a simple circuit switch could be completed when second side is in contact with a positive and negative terminal to signify a first state position, and broken when second side 66 is not in contact with the terminals to signify a second state position.

Diaphragm 36 may be manufactured to assume its shape based solely as a function of pressure exerted by fluid 59, having a continuous range of conformations existing between the first state and second state. Alternatively, diaphragm 36 may be manufactured having discrete confirmations that change as a function of both pressure exerted by fluid 59 and mechanic bias of diaphragm 36 introduced by its structure and/or material composition. In the example shown in FIGS. 3A and 3B, diaphragm 36 is a bi-state diaphragm resiliently biased toward the second state such that it will only occupy the first state at or beyond a threshold pressure exerted on first side 64 to overcome the bias, and will only occupy the second state below the threshold pressure. The threshold pressure may be set, for example, as the pressure at which an “empty” or “insufficient pressure” signal should be indicated. The threshold pressure for a fire extinguisher, for example, may range from about 690 kilopascals (or about 100 pounds per square inch) to about 1345 kilopascals (or about 195 pounds per square inch). More specifically, for fire extinguisher 10, diaphragm 36 should remain in the first state as long as the extinguisher tank is pressurized to about 690 kilopascals (or about 100 pounds per square inch) for a residential fire extinguisher 10, and about 1345 kilopascals (or about 195 pounds per square inch) for a commercial fire extinguisher 10. Alternatively, the pressure threshold may be set as a discrete range, such as positive or negative 5% of a full charge, for example. By using a bi-state diaphragm in combination with a simple miniature switch, the cost of manufacturing pressure gauge 20 is significantly reduced in comparison with the relatively complicated structure of a bourdon tube.

FIG. 4A and FIG. 4B are frontal views of pressure gauge 20, showing indicator 42 as an LCD for indicating whether vessel 22 is “full” or “empty,” respectively. Pressure gauge will indicate “full” when diaphragm 36 is in the first state (see FIG. 4A), and “empty” when diaphragm 36 is in the second state (see FIG. 4B), for example. Alternatively, it may be appreciated that other textual displays could be used, for example, “good” or “bad,” “sufficient” or “insufficient,” and “ok” or “replace.” Further shown is battery level indicator 70, which is optionally provided to indicate the level of power remaining in battery 48. Although an LCD is shown as the indicator in FIGS. 4A and 4B, it may be appreciated that other means of indication may be provided for indicating whether pressure in vessel 22 is sufficient or insufficient. For example, sufficient or full pressure could be indicated with a green LED, while insufficient pressure or an empty condition could be indicated with a red LED. Alternatively, it may be appreciated that other colors could be used, such as blue for sufficient pressure and orange for insufficient pressure, for example. Furthermore, LEDs may be used in combination with an LCD display to ensure that the indication of pressure on pressure gauge 20 is more easily understood regardless of whether the user is more receptive to color coding or textual information.

FIGS. 5A and 5B are an electrical block diagram of a pressure gauge, further showing an embodiment having an optional wireless transceiver 72, and wherein sensor 68 is a miniature switch and circuit 40 is an integrated circuit 40. As shown in FIG. 5A, when fluid 59 acts upon diaphragm 36 at a sufficient pressure, it occupies a first state, causing the switch to close (i.e., turn “on”) and communicate a signal to integrated circuit 40 representing the first state. Integrated circuit 40 may comprise a microprocessor, for example, which processes the sensor 68 signal representing the sensed first state and signals indicator 42 to indicate a “full” or green light status corresponding to sufficient pressure exerted from fluid 59. In response to the first state signal communicated by sensor 68, integrated circuit 40 further signals alarm 44 to remain off.

As shown in FIG. 5B, a lack of sufficient pressure from fluid 59 causes diaphragm 36 to occupy a second state, further causing miniature switch to open (i.e., turn “off”) and communicate a signal to integrated circuit 40 representing the second state. Integrated circuit 40 processes the signal representing the second state and signals indicator to indicate an “empty” or red light status corresponding to insufficient pressure exerted from fluid 59. In response to the sensed second state communicated by sensor 68, integrated circuit 40 further signals alarm 44 to turn on, for example, by sounding a buzzer. This provides an effective way to indicate to a user when a vessel 22 attached to pressure gauge 20 has become underpressurized, even if vessel 22 is not commonly in view. For example, fire extinguishers 10 are often stored in enclosed spaces such as cabinets. For residential fire extinguishers 10, monitoring of pressure in the extinguisher tank is not regulated by law, and therefore it is common for tanks to go unchecked for years. By sounding an alarm when the tank becomes underpressurized, even owners of residential fire extinguishers 10 may be assured they will be notified if their tank becomes unsuitable for use and needs service or replacement. It may be appreciated that alarm 44 could also be turned on when integrated circuit 40 processes a low battery 48 signal, for example.

The optional wireless transceiver 72 shown in FIGS. 5A and 5B may be provided to add further useful safety features and functionality to pressure gauge 20. In one embodiment, integrated circuit 40 may process a signal indicating a first or second state of diaphragm 36 and signal wireless transceiver 72 to emit a wireless signal indicating a “full” or “empty” pressure condition in vessel 22, for example. To save battery 48 power, this signal could be emitted periodically or only when cued by an external device transmitting a request to wireless transceiver 72. The wireless signal may then be received by a handheld device or computer, for example, for display and/or further processing. This would allow a service technician to visit a building or general area in which pressure gauge 20 is utilized and quickly receive a pressure status indication for all pressurized vessels 22 within wireless communication range, without the need for physically inspecting each individual vessel. Furthermore, a wireless signal sent from wireless transceiver 72 may also be transmitted to a local device linked to the internet, allowing communication with a remote control center, and enabling it to monitor the pressure status of vessels in communication with the local device. It may be appreciated that the wireless signal could be sent as a radiofrequency signal, Bluetooth signal, or any other suitable form of wireless communication.

In another embodiment, optional wireless transceiver 72 may be used in conjunction with a wireless fire or smoke detector system employing a wireless communication network. In a wireless fire or smoke detector network, each detector in a building is linked to the other detectors or to a central control unit via wireless communication, such that when one detector senses the presence of smoke or fire and sounds its alarm, it communicates a signal to the other detectors in the network to sound their alarm. Similarly, wireless transceiver 72 may be used to enroll pressure gauge 20 as part of a wireless fire or smoke detector network, such that wireless transceiver 72 receives a signal from a detector indicating the presence of a fire, processes the signal using integrated circuit 40, and responds by signaling alarm 44 to turn on. Additionally, integrated circuit 40 may signal a light on indicator 42 to repeatedly flash in response to a received signal indicating the presence of fire. This would ensure that fire extinguishing vessel 10 utilizing pressure gauge 20 may be found quickly and easily in a fire emergency situation.

Although head 12 has been shown in the present disclosure as that typically used for a fire extinguisher 10, vessel 22 could be any tank or housing capable of containing a fluid under pressure, including but not limited to scuba diving air tanks or compressed gas tanks for use in laboratories or industrial processes, for example. Furthermore, it may be appreciated that other heads or valves suitable for a particular vessel 22 may be employed in combination with pressure gauge 20.

Thus, although the present invention has been described with reference to preferred embodiments, workers skilled in the art will recognize that changes may be made in form and detail without departing from the spirit and scope of the invention.

1. A pressure gauge comprising:
a bi-state diaphragm having a first side and a second side, the diaphragm occupying a first state at or above a threshold pressure of a fluid in contact with the first side and resiliently biased to occupy a second state below a threshold pressure of the fluid in contact with the first side;
a switch sensing the second side of the diaphragm and occupying an open or closed state in response to the first state and the second state of the diaphragm;
a circuit for processing a signal from the switch representing the open or closed state to provide an output;
an indicator for providing a visual output representing the first state or the second state of the diaphragm based on the output from the circuit;
a printed circuit board supporting the switch, the circuit, and the indicator; and
a housing enclosing the printed circuit board, the switch, the circuit, and the indicator.

2. The pressure gauge of claim 1, wherein the switch is closed when the diaphragm is in the first state.

3. The pressure gauge of claim 1, further comprising an alarm for providing an audible output representing the first state or the second state of the diaphragm based on the output from the circuit.

4. The pressure gauge of claim 3, wherein the alarm is a piezoelectric buzzer that turns on to indicate the second state of the diaphragm.

5. The pressure gauge of claim 1, wherein the indicator comprises a liquid crystal display.

6. The pressure gauge of claim 1, wherein the indicator comprises a light emitting diode.

7. A head comprising:
a body for attachment to a pressurized vessel and having a passage for directing fluid from the pressurized vessel;
a housing attached to the body and having an enclosed space separated from the passage by a bi-state diaphragm having a first side facing the passage and a second side facing the enclosed space, the diaphragm occupying a first state at or above a threshold pressure of a fluid in contact with the first side and resiliently biased to occupy a second state below a threshold pressure of the fluid in contact with the first side;
a sensor in the enclosed space for sensing the first state or the second state of the diaphragm and producing a signal representing the sensed first state or the sensed second state;
a circuit in the enclosed space for processing the signal representing the sensed first state or the sensed second state to provide an output; and
an indicator in the enclosed space for providing a visual output representing the sensed first state or the sensed second state of the diaphragm based on the output from the circuit.

8. The head of claim 7, wherein the diaphragm spans the passage to form a leakproof seal between the passage and the enclosed space.

9. The head of claim 8, wherein the diaphragm is integrally molded with the passage.

10. The head of claim 8, wherein the diaphragm is laser welded to the passage.

11. The head of claim 8, wherein the diaphragm is adhered to the passage using an adhesive.

12. A fire extinguisher comprising:
a vessel containing an extinguishing agent under pressure;
a head attached to the vessel having a pressure sensor, a first passage for directing the extinguishing agent from the vessel to an outlet, and a second passage for directing the extinguishing agent to the pressure sensor, the pressure sensor comprising:
a bi-state diaphragm communicating with the second passage and occupying a first state at or above a threshold pressure of the extinguishing agent in contact with the diaphragm and a second state below a threshold pressure of the extinguishing agent in contact with the diaphragm;
a switch for sensing the first state or the second state of the diaphragm and producing a signal representing the sensed first state or the sensed second state;
a circuit for processing the signal representing the sensed first state or the sensed second state to provide an output;
an indicator for providing a visual output representing the first state or the second state of the diaphragm based on the output from the circuit; and
an alarm for providing an audible output representing the first state or the second state of the diaphragm based on the output from the circuit.

13. The fire extinguisher of claim 12, wherein the diaphragm is resiliently biased to occupy the second state below the threshold pressure of the fluid in contact with the diaphragm.

14. The fire extinguisher of claim 12, wherein the diaphragm comprises a plastic, metal or metal alloy.

15. The fire extinguisher of claim 12, wherein the threshold pressure of the extinguishing agent is between about 690 kilopascals to about 1345 kilopascals.

16. The fire extinguisher of claim 12, wherein the indicator comprises a light emitting diode.

17. The fire extinguisher of claim 12, wherein the indicator comprises a liquid crystal display.

18. The fire extinguisher of claim 12, wherein the alarm is a piezoelectric buzzer that turns on to indicate the second state of the diaphragm.

19. The fire extinguisher of claim 12, further comprising a wireless transceiver, and wherein the wireless transceiver emits a wireless signal representing the first state or the second state of the diaphragm based on the output from the circuit.

20. The fire extinguisher of claim 12, further comprising a wireless transceiver, and wherein the wireless transceiver functions to receive a wireless signal from an external device indicating a fire emergency condition.
